(19) United States
(12) Patent Application Publication
(10) Pub. No.: US 2025/0284229 A1
(43) Pub. Date: Sep. 11, 2025

(54) FIXING DEVICE

(71) Applicant: CANON KABUSHIKI KAISHA, Tokyo (JP)

(72) Inventors: KEISUKE YOSHIDA, Chiba (JP); HIDEKAZU TATEZAWA, Saitama (JP); YOUICHI CHIKUGO, Chiba (JP); YUYA YAMADA, Chiba (JP)

(21) Appl. No.: 19/061,244

(22) Filed: Feb. 24, 2025

(30) Foreign Application Priority Data
Mar. 8, 2024 (JP) 2024-035941

(51) Int. Cl. G03G 15/20

(52) U.S. Cl. CPC G03G 15/2017; G03G 15/2064; G03G 2215/2038

(57) ABSTRACT

A fixing device includes a belt unit including a rotating endless belt, a stretching roller, a first support plate, and a second support plate, a rotatable pressing member disposed outside the belt and forming a nip portion capable of sandwiching and conveying the recording material together with the belt, a frame supporting the first support plate and the second support plate, an adjustment unit provided on the frame and being capable of adjusting a position of the first support plate in a direction intersecting with the rotation axis direction, and a cover member covering the belt unit, the frame, and the adjustment unit. The cover member includes an opening portion formed at a position corresponding to the adjustment unit and communicating with an outside.

### BACKGROUND OF THE INVENTION

### Field of the Invention

The present invention relates to a fixing device suitable for use in an image forming device such as a printer, a copier, a facsimile, or a multifunction machine.

### Description of the Related Art

In an image forming device, a toner image that is not fixed to a recording material is formed, and the toner image is heated and pressurized by a fixing device to be fixed to the recording material. As an example of the fixing device, Japanese Patent Application Laid-Open Publication No. 2008-33227 proposes a belt heating-type fixing device using a belt. In the case of the belt heating type, in a case where the rotation axis directions of stretching rollers that stretch a belt are not parallel and are out of sync (referred to as an alignment error), belt tracking in which the rotating belt moves in the width direction intersecting with the rotation direction aside the end portions of the stretching rollers may occur. In a case where belt tracking occurs, the moved belt may come into contact with other members, and the belt or other members may be damaged. Therefore, steering control of adjusting belt tracking by detecting the widthwise position of the belt end portion by a sensor and swinging one of the stretching rollers (referred to as a steering roller) based on the detection result to change the relative angle of the steering roller with respect to the other stretching roller is performed.

### SUMMARY OF THE INVENTION

According to one aspect of the present invention, a fixing device that fixes a toner image formed on a recording material to the recording material, includes a belt unit including a rotating endless belt, a stretching roller disposed inside the belt and configured to stretch the belt, a first support plate supporting one end portion of the stretching roller in a rotation axis direction, and a second support plate supporting the other end portion of the stretching roller in the rotation axis direction, a rotatable pressing member disposed outside the belt and forming a nip portion capable of sandwiching and conveying the recording material together with the belt, a frame supporting the first support plate and the second support plate, an adjustment unit provided on the frame and being capable of adjusting a position of the first support plate in a direction intersecting with the rotation axis direction, and a cover member covering the belt unit, the frame, and the adjustment unit. The cover member includes an opening portion formed at a position corresponding to the adjustment unit and communicating with an outside.

Further features of the present invention will become apparent from the following description of exemplary embodiments with reference to the attached drawings.

### BRIEF DESCRIPTION OF THE DRAWINGS

FIG. 1 is a schematic view showing an image forming device suitable for using a fixing device of the present embodiment.

FIG. 2 is a schematic view showing a fixing device according to a first embodiment.

FIG. 3 is a schematic view showing a belt unit.

FIG. 4 is a cross-sectional view showing a pressing mechanism of the first embodiment.

FIG. 5 is a schematic view showing a fixing device of a second embodiment.

FIG. 6 is a cross-sectional view showing a pressing mechanism of the second embodiment.

FIG. 7 is a schematic view showing a fixing device of a third embodiment.

FIG. 8 is a cross-sectional view showing a pressing mechanism of the third embodiment.

FIG. 9 is a schematic view showing a case where a grip portion is provided in the pressing mechanism.

FIG. 10 is a schematic view showing a case where a cover member is in an open position.

### DESCRIPTION OF THE EMBODIMENTS

### First Embodiment

### Image Forming Device

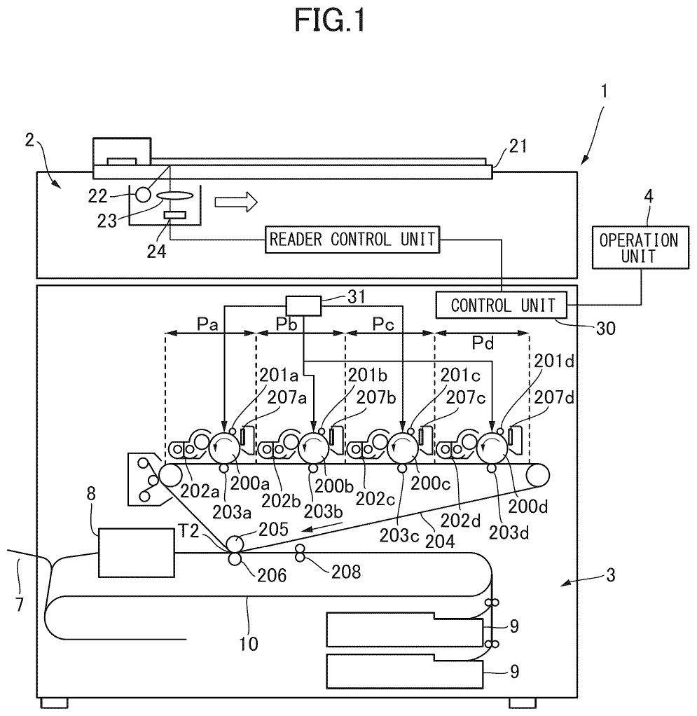

The present embodiment will be described. First, the configuration of an image forming device suitable for using a fixing device of the present embodiment will be described using FIG. 1. An image forming device 1 is an electrophotographic full-color printer including four image forming units Pa, Pb, Pc, and Pd provided to correspond to four colors of yellow, magenta, cyan, and black. The present embodiment is a tandem type image forming device 1 in which the image forming units Pa, Pb, Pc, and Pd are disposed along a rotation direction of an intermediate transfer belt 204. The image forming device 1 forms a toner image (image) on a recording material according to an image signal from an external host device such as a print server connected in a communicable manner to a document reading device 2 connected to a device main body 3 of the image forming device 1 or the device main body 3. Examples of the recording material include sheet materials such as paper, a plastic film, and cloth.

As shown in FIG. 1, the image forming device 1 includes the document reading device 2 and the device main body 3. The document reading device 2 is a device configured to read a document placed on a document table glass 21, light radiated from a light source 22 is reflected by the document, and an image is formed on a CCD sensor 24 via an optical system member 23 such as a lens. In a case where such an optical system unit has been scanned in a direction of an arrow under the control by a reader control unit, the optical system unit reads the document line by line and converts the document into electric signal data strings. An image signal obtained by the CCD sensor 24 is sent to the device main body 3, and image processing corresponding to each image forming unit described later is performed by a control unit 30. In addition, the control unit 30 also receives an external input from an external host device such as a print server as an image signal.

The device main body 3 includes a plurality of image forming units Pa, Pb, Pc, and Pd, and image formation is performed in each image forming unit based on the image signal described above. That is, the image signal is converted into a PWM (pulse width modulation-controlled) laser beam by the control unit 30. A polygon scanner 31 serving as an exposure device scans the laser beam according to the image signal. Then, photosensitive drums 200a to 200d serving as image carriers of the image forming units Pa to Pd are irradiated with laser beams.

The image forming unit Pa forms a yellow color (Y) toner image, the image forming unit Pb forms a magenta color (M) toner image, the image forming unit Pc forms a cyan color (C) toner image, and the image forming unit Pd forms a black color (Bk) toner image. Since these image forming units Pa to Pd have substantially the same configuration, the image forming unit Pa configured to form a yellow color (Y) toner image will be described below as an example, and the description of the other image forming units Pb to Pd will be omitted. In the image forming unit Pa, a toner image is formed on the surface of the photosensitive drum 200a based on the image signal.

A charging roller 201a charges the surface of the photosensitive drum 200a to a predetermined potential to prepare for the formation of an electrostatic latent image. An electrostatic latent image is formed on the surface of the photosensitive drum 200a charged to a predetermined potential by the laser beam from the polygon scanner 31. A developer 202a develops the electrostatic latent image on the photosensitive drum 200a to form a toner image. A primary transfer roller 203a performs discharge from the back surface of an intermediate transfer belt 204, applies a primary transfer bias having a polarity opposite to that of a toner, and transfers the toner image on the photosensitive drum 200a onto the intermediate transfer belt 204. The surface of the photosensitive drum 200a after the transfer is cleaned by a cleaner 207a.

In addition, the toner image on the intermediate transfer belt 204 moves to the next image forming unit, toner images of respective colors formed by the image forming units Pa to Pd sequentially in the order of Y, M, C, and Bk are transferred, and an image of four colors is formed on the surface of the intermediate transfer belt 204. Then, the toner image that has passed through the image forming unit Pd present most downstream in the rotation direction of the intermediate transfer belt 204 moves to a secondary transfer portion T2 composed of a pair of secondary transfer rollers 205 and 206. Then, in the secondary transfer portion T2, the toner image is secondarily transferred from the intermediate transfer belt 204 to a recording material by applying a secondary transfer electric field having a polarity opposite to the polarity of the toner image on the intermediate transfer belt 204.

The recording material is accommodated in a cassette 9, and the recording material fed from the cassette 9 is conveyed to, for example, a registration unit 208 composed of a pair of registration rollers and waits at the registration unit 208. Thereafter, a timing is controlled by the registration unit 208 to align the toner image on the intermediate transfer belt 204 with the position of paper, and the recording material is conveyed to the secondary transfer portion T2.

The recording material onto which the toner image has been transferred in the secondary transfer portion T2 is conveyed to a fixing device 8, and the toner image is fixed to the recording material by applying heat and pressure in the fixing device 8. The recording material that has passed through the fixing device 8 is discharged to a discharge tray 7. In a case where images are formed on both surfaces of the recording material, when the transfer and fixing of a toner image to a first surface (front surface) of the recording material are completed, the front and back of the recording material are reversed through a reverse conveying unit 10, the transfer and fixing of a toner image to a second surface (back surface) of the recording material are performed, and the recording material is discharged onto the discharge tray 7.

The control unit 30 controls the entire image forming device 1. The control unit 30 has a central processing unit (CPU), a read only memory (ROM), and a random access memory (RAM). The CPU controls each unit while reading out a program corresponding to a control procedure stored in the ROM. The RAM stores work data or input data, and the CPU performs control with reference to data stored in the RAM based on the above-described program or the like. The control unit 30 can perform various settings and the like based on an input from an operation unit 4 in the image forming device 1. The operation unit 4 may be, for example, a touch panel, and receives start inputs of various programs such as an “image forming job” and various data inputs according to a user's touch operation.

### Fixing Device

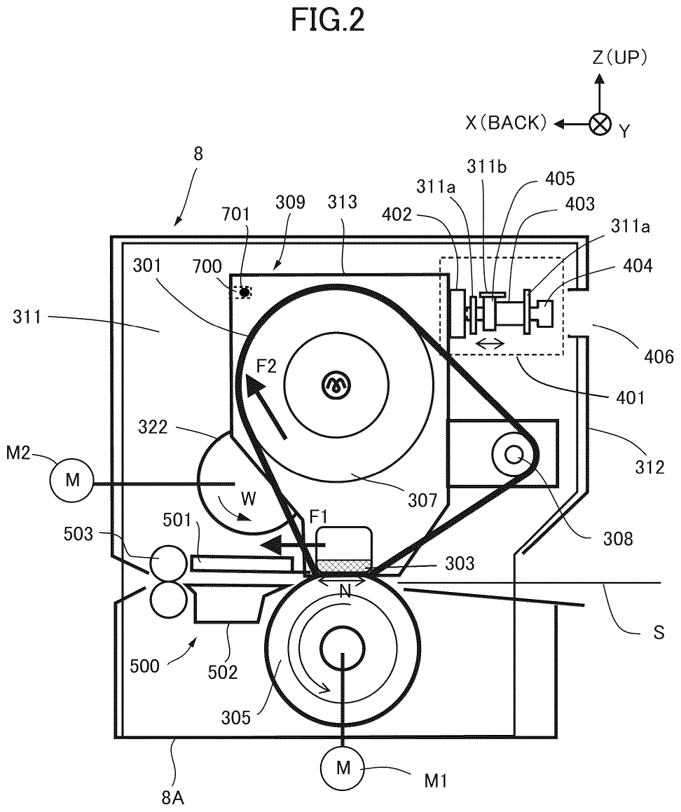

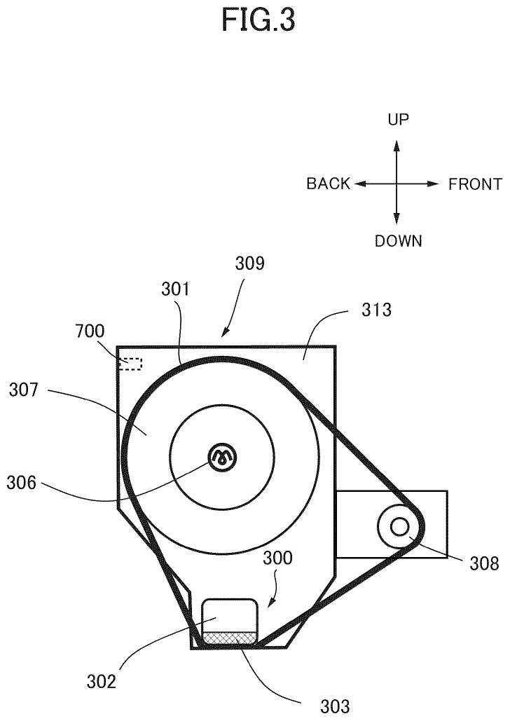

Next, the fixing device 8 of the present embodiment will be described using FIG. 2 and FIG. 3. In the present embodiment, a belt heating-type fixing device 8 using an endless fixing belt 301 is adopted. In FIG. 2, “X” indicates a conveying direction of a recording material S, “Y” indicates a width direction, and “Z” indicates a pressurizing direction. In the present specification, the width direction (left-right direction) is a direction intersecting with the conveying direction of the recording material S in a fixing nip portion N described later, in other words, a rotation axis direction of a pressing roller 305. In addition, a case where the fixing device 8 is viewed from the upstream side in the conveying direction is referred to as “front (or front surface)”, a side opposite to the front surface is referred to as “back”, the left side as viewed from the front surface is referred to as “left”, and the right side as viewed from the front surface is referred to as “right”. FIG. 2 and FIG. 3 show the fixing device 8 and a belt unit 309 as viewed from the left.

As shown in FIG. 2, the fixing device 8 includes a fixing frame 8A, the belt unit 309, the pressing roller 305, a discharge unit 500, and a pressing mechanism 401. Although not shown, the fixing frame 8A is composed of pillars extending in the up-down direction at four corners, connection stays that connect the pillars each other in the left-right direction (width direction) or the front-back direction, and the like. Frame side plates 311 constituting a part of the fixing frame 8A are disposed at both ends of the fixing frame 8A in the left-right direction. The frame side plates 311 support the belt unit 309, the pressing roller 305, and the discharge unit 500. In addition, a cover member 312 is installed on the fixing frame 8A to cover the belt unit 309. The cover member 312 is screwed to the fixing frame 8A in a closed state.

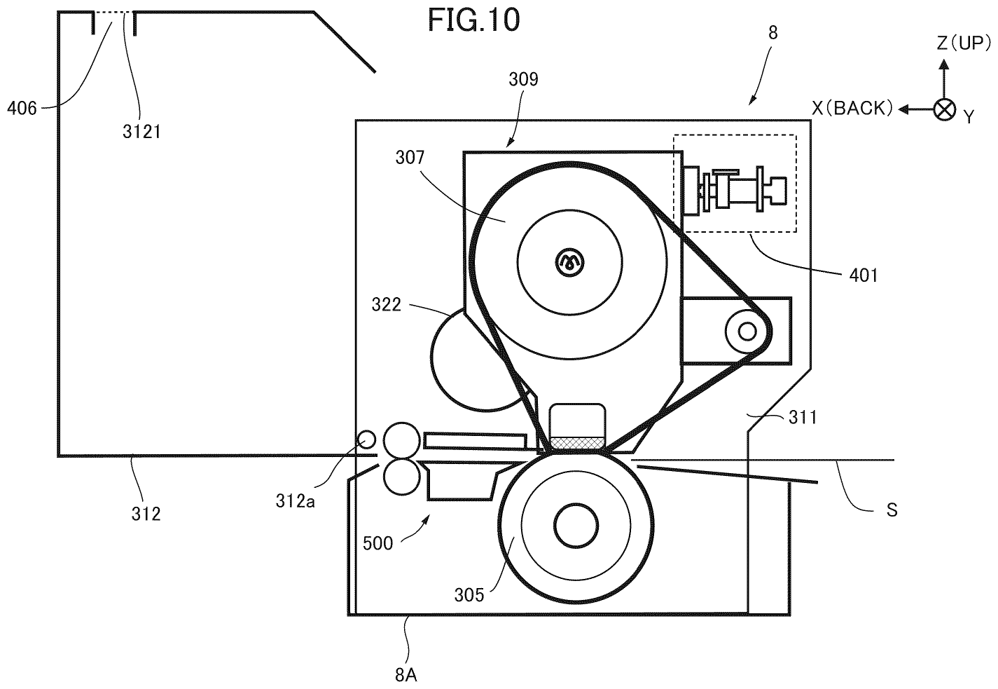

Here, the cover member 312 is provided to be movable between a closed position in a closed state where the belt unit 309 is not exposed shown in FIG. 2 and an open position in an open state where the belt unit 309 is exposed as shown in FIG. 10. The cover member 312 is screwed with a screw (not shown) to the fixing frame 8A at the closed position in the closed state, and the fixing device 8 can perform fixing operation in a state where the cover member 312 remains screwed. Incidentally, in the case of maintenance work of the belt unit 309 or the like of the fixing device 8, the belt unit 309 must be exposed. Therefore, the cover member 312 is provided to be movable from the closed position to the open position in a state where the screw has been removed. For example, as shown in FIG. 10, the cover member 312 is provided such that an operator can open the cover member 312 from the front side toward the back side around a rotational movement axis 312a disposed downstream of the discharge unit 500 in the conveying direction of the recording material S as a rotational movement center.

### Pressing Roller

The pressing roller 305 serving as a rotatable pressing member is rotatably pivoted by the left and right frame side plates 311 at both end portions in the width direction so as to be capable of pressurizing the fixing belt 301 of the belt unit 309 while abutting on the fixing belt 301. A gear (not shown) is fixed to one end portion of the pressing roller 305, and the pressing roller 305 is connected to a motor Ml via the gear and driven to rotate.

The pressing roller 305 is a roller in which a cylindrical core metal, an elastic layer on the outer circumference of the core metal, and furthermore, a release layer on the elastic layer are formed. As an example, a stainless steel (SUS) having a diameter of “72 mm” is used as the core metal, a conductive silicone rubber having a thickness of “8 mm” is used as the elastic layer, and the release layer is formed using a tetrafluoroethylene-perfluoroalkoxyethylene copolymer resin (PFA) having a thickness of “100 μm”.

The pressing roller 305 abuts on the outer peripheral surface of the fixing belt 301 so as to sandwich the fixing belt 301 between a pressurizing pad 303 of the belt unit 309 and the pressing roller 305, and forms the fixing nip portion N where the recording material S can be sandwiched and conveyed to fix the toner image on the recording material S. For this purpose, the pressing roller 305 is provided to be movable toward the pressurizing pad 303 by a driving source not shown. In the case of the present embodiment, the pressing roller 305 presses the fixing belt 301 such that, for example, the pressurizing force in the fixing nip portion N at the time of image formation becomes “1600 N”, the length of the fixing nip portion N in the conveying direction becomes “24.5 mm”, and the length of the fixing nip portion N in the width direction becomes “326 mm”. The belt unit 309 receives a force corresponding to a driving force of the pressing roller 305 in a direction of an arrow F1 in the fixing nip portion N.

### Discharge Unit

The discharge unit 500 for discharging the recording material S that has passed through the fixing nip portion N to the outside of the fixing frame 8A is disposed downstream of the fixing nip portion N in the conveying direction. The discharge unit 500 includes an air nozzle 501 configured to blow a compressed air for peeling the recording material S that has passed through the fixing nip portion N off from the fixing belt 301, a lower separation guide 502 for peeling the recording material S off from the pressing roller 305, and a pair of conveying rollers 503 configured to convey the peeled recording material S.

### Belt Unit

FIG. 3 is a schematic view showing the belt unit. As shown in FIG. 3, the belt unit 309 includes the endless fixing belt 301, a heating roller 307, a steering roller 308, a fixing pad unit 300, and belt unit side plates 313. The belt unit side plates 313 are disposed to face each other on both end sides in the width direction (front-back direction) (a first support plate and a second support plate), and support one end portion and the other end portion of each of the heating roller 307, the steering roller 308, and a holding stay 302.

The holding stay 302 of the fixing pad unit 300 is formed to be long enough to protrude outward from the left and right belt unit side plates 313 in the width direction, and the belt unit side plates 313 are fixed in the middle of the holding stay 302 of the fixing pad unit 300. The frame side plates 311 are provided with fitting portions (not shown) into which both end portions of the holding stay 302 can be fitted. In addition, a fitting groove 700 is formed on the upper side of the belt unit side plate 313 on the downstream side (here, the left side) in the conveying direction. On the other hand, as shown in FIG. 2, the frame side plate 311 is provided with a protruding portion 701 protruded to be fittable into the fitting groove 700. In the case of the present embodiment, the belt unit 309 is moved from front to back with respect to the side plates 313, that is, in the conveying direction (the arrow X direction), whereby the holding stay 302 is fitted into the fitting portions, and the protruding portions 701 are fitted into the fitting grooves 700. In other words, the portions of the holding stay 302 that protrude outward from the belt unit side plates 313 in the width direction function as support portions that support the belt unit side plates 313 to the frame side plates 311. The belt unit 309 is supported by the frame side plates 311 via the holding stay 302 and the protruding portions 701 as described above. Therefore, the heating roller 307 and the steering roller 308 are supported only by the belt unit side plates 313 and are not supported by the frame side plates 311.

### Fixing Belt

The fixing belt 301 is stretched by two stretching rollers of the heating roller 307 and the steering roller 308 and the fixing pad unit 300. The fixing belt 301 has thermal conductivity, heat resistance, or the like, and is formed in a thin cylindrical shape. The fixing belt 301 has a three-layer structure in which a base layer, an elastic layer, and a release layer are formed on a base material such as rubber in order from the inner peripheral side. As an example, a polyimide resin (PI) having a thickness of “80 μm” is used as the base layer, silicone rubber having a thickness of “300 μm” is used as the elastic layer, and PFA having a thickness of “30 μm” is used as the release layer.

### Heating Roller

The heating roller 307 serving as the stretching roller is disposed inside the fixing belt 301 and is rotatably pivoted by the belt unit side plates 313 so as to stretch the fixing belt 301 together with the fixing pad unit 300. The heating roller 307 is a metal roller formed of, for example, a metal such as aluminum or stainless steel having a thickness of “1 mm” in a cylindrical shape, and a halogen heater 306 for heating the fixing belt 301 is disposed inside the heating roller 307. The heating roller 307 is heated up to a predetermined temperature by the halogen heater 306, whereby the fixing belt 301 is heated by the heating roller 307. A gear (not shown) is fixed to the right end portion of the heating roller 307, and the heating roller 307 is driven to rotate by a motor M2 via a driving gear unit 322 that is installed in the fixing frame 8A. The driving gear unit 322 serving as a driving transmission member transmits a driving force from the motor M2 serving as a driving source to the heating roller 307 in an arrow W direction to rotate the heating roller 307. The heating roller 307 and the pressing roller 305 may be driven to rotate by any one of the motor M1 or the motor M2 as a common driving source. For example, in a case where the motor M1 is a common driving source, the driving gear unit 322 is rotated in the arrow W direction by the motor M1.

### Fixing Pad Unit

The fixing pad unit 300 serving as a stretching member has the holding stay 302 and the pressurizing pad 303, is disposed inside the fixing belt 301, and is attached to the belt unit side plates 313. The holding stay 302 is, for example, a stiff metal member that extends in the width direction of the fixing belt 301, and holds the pressurizing pad 303. The pressurizing pad 303 serving as a pad member is provided inside the fixing belt 301 in a non-rotating manner. The pressurizing pad 303 is a resin member that extends in the width direction, and the widthwise length of the pressurizing pad 303 is longer than the widthwise length of the recording material having the maximum size capable of forming an image. The pressurizing pad 303 is formed of, for example, a resin having good insulating properties and heat resistance, such as a liquid crystal polymer resin (LCP).

In order to reduce the frictional force between the fixing belt 301 and the pressurizing pad 303, it is preferable that a sliding member (not shown) is provided between the pressurizing pad 303 and the fixing belt 301. The sliding member is disposed at a position facing the pressing roller 305 with the fixing belt 301 interposed therebetween. In addition, it is preferable that a lubricant such as silicone oil is applied to the inner peripheral surface of the fixing belt 301 in order to smoothly slide the fixing belt 301 on the sliding member.

In the present embodiment, the fixing belt 301 is pressed against the pressurizing pad 303 held by the holding stay 302 from the outside by the pressing roller 305. Thereby, a fixing nip portion N with a wide nip in which the length in the conveying direction and the widthwise length have been secured as described above is formed between the pressing roller 305 and the fixing belt 301. In addition, the resin pressurizing pad 303 is held by the holding stay 302 made of a highly stiff metal, whereby deflection of the pressurizing pad 303 caused by the pressure during pressing is reduced, and a uniform fixing nip width in the width direction is obtained.

### Steering Roller

In the belt unit 309, due to the accuracy of a component, a so-called alignment error may occur in which the rotation axis directions of the stretching rollers that stretch the fixing belt 301 are not parallel and are out of sync. In that case, belt tracking in which the rotating fixing belt 301 moves aside the end portion in the width direction is likely to occur, and the fixing belt 301 or other members may be damaged. Therefore, in the present embodiment, in order to suppress belt tracking, one of the plurality of stretching rollers that stretch the fixing belt 301 is used as the steering roller 308. The steering roller 308 is, for example, a member in which a rubber material for increasing the grip force with respect to the fixing belt 301 is provided on a surface of a hollow metal shaft (for example, a stainless steel shaft) formed in a diameter of “φ20 mm”.

In the case of the present embodiment, the steering roller 308 is disposed downstream of the heating roller 307 and upstream of the pressurizing pad 303 in the rotation direction of the fixing belt 301. The steering roller 308 controls the position of the rotating fixing belt 301 in the width direction. The steering roller 308 has a swing center at the center portion in the width direction and is provided such that the steering roller 308 can be tilted with respect to the fixing belt 301 by a steering mechanism, not shown. Since a tension difference is generated between both end portions of the fixing belt 301 depending on the tilting of the steering roller 308, the fixing belt 301 moves in the width direction. As described above, in the present embodiment, in a case where the alignment error occurs due to the accuracy of a component as in the related art, belt tracking can be suppressed by the steering roller 308.

By the way, in recent years, in order to handle an increase in the speed of image formation, the rotation speed of the fixing belt 301 may be increased, and the pressurizing force in the fixing nip portion N may be increased. In such a case, it is necessary to increase the driving torque of the heating roller 307, and the rotational driving force that the heating roller 307 receives from the driving gear unit 322 is thus increased. However, depending on the magnitude of the rotational driving force, the driving gear unit 322 side of the belt unit 309 may receive a large force in an arrow F2 direction (refer to FIG. 2), and the belt unit side plates 313 on the driving gear unit 322 side (here, the right side) may deform. In a case where one of the left and right belt unit side plates 313 deforms, there is a concern that a larger alignment error may occur, and it is difficult to suppress belt tracking by the steering roller 308.

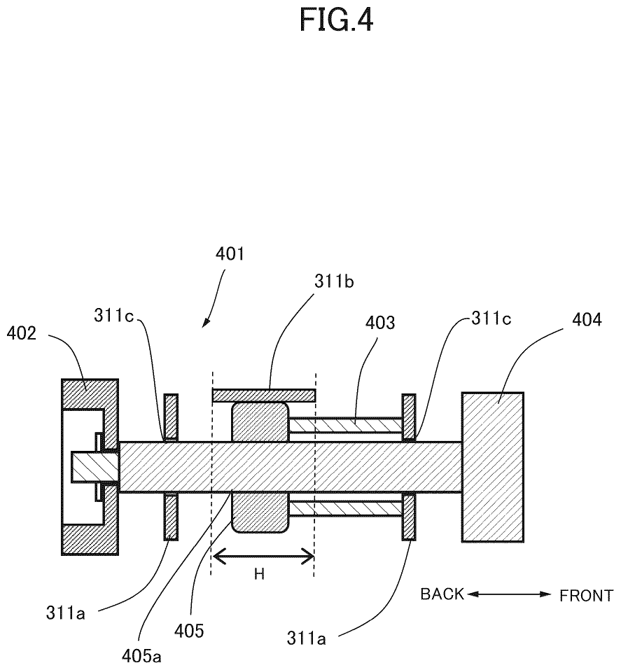

In view of the above-described point, in the present embodiment, the operator is enabled to manually adjust the alignment between the stretching rollers in the belt unit 309 from the outside of the fixing frame 8A to an extent that belt tracking can be suppressed by the steering roller 308. Hereinafter, the pressing mechanism 401 for implementing the adjustment will be described using FIG. 2 and FIG. 4. FIG. 4 is a cross-sectional view showing the pressing mechanism of the first embodiment.

### Pressing Mechanism

As shown in FIG. 2 and FIG. 4, the pressing mechanism 401 is composed of an abutting member 402, a spring member 403, an adjustment screw 404, an adjustment frame 405, attachment members 311a, and a rotation restricting member 311b. The pressing mechanism 401 is attached to the fixing frame 8A via two attachment members 311a fixed to the fixing frame 8A (specifically, the frame side plate 311) in advance. The attachment members 311a are disposed side by side at an interval in the front-back direction. Through holes 311c are formed in the attachment members 311a, and the shaft portion of the adjustment screw 404 is inserted into these through holes 311c, whereby the adjustment screw 404 is supported by the attachment members 311a so as to be reciprocally movable in the front-back direction.

In the adjustment screw 404 supported by the two front and back attachment members 311a, the adjustment frame 405 is disposed between the attachment members 311a. The adjustment frame 405 is formed in, for example, a polygonal shape such as a hexagonal shape. A helical groove is formed in the shaft portion of the adjustment screw 404, and a screw hole 405a that meshes with the shaft portion of the adjustment screw 404 is formed in the adjustment frame 405. That is, the adjustment frame 405 is provided to allow the shaft portion of the adjustment screw 404 to move by the rotation of the adjustment screw 404.

In the present embodiment, the rotation restricting member 311b is fixed to the fixing frame 8A in the same manner as the attachment members 311a. The rotation restricting member 311b abuts on one surface of the outer peripheral surface of the adjustment frame 405, and restricts the rotation of the adjustment frame 405 such that the adjustment frame 405 does not rotate together with the adjustment screw 404 in a case where the adjustment screw 404 is rotated. In this way, the adjustment frame 405 allows the shaft portion of the adjustment screw 404 to reciprocally move within a range H in the front-back direction of the rotation restricting member 311b by the rotation of the adjustment screw 404. Accordingly, the position of the adjustment frame 405 changes on the shaft portion of the adjustment screw 404 by the rotation of the adjustment screw 404. For example, in a case where the adjustment screw 404 is rotated clockwise, the adjustment frame 405 moves from the back side to the front side with respect to the shaft portion, and in a case where the adjustment screw 404 is rotated counterclockwise, the adjustment frame 405 moves from the front side to the back side with respect to the shaft portion.

In addition, in a state where the shaft portion of the adjustment screw 404 has been inserted into the front and back attachment members 311a, the spring member 403 (a first elastic member and a second elastic member) inserted into the shaft portion of the adjustment screw 404 are disposed between the adjustment frame 405 and the front attachment member 311a. The spring member 403 is provided to urge the abutting member 402 toward the belt unit side plate 313, and the adjustment screw 404 can adjust the urging force of the spring member 403.

In the case of the present embodiment, one end of the spring member 403 is connected to the adjustment frame 405, the other end of the spring member 403 is connected to the front attachment member 311a, and the spring member 403 applies a force of pulling the adjustment frame 405 to the front side with reference to the front attachment member 311a. As described above, in a case where the adjustment frame 405 moves with respect to the shaft portion of the adjustment screw 404 by the rotation of the adjustment screw 404, the interval between the adjustment frame 405 and the front attachment member 311a changes, and the spring member 403 thus expands and contracts. The abutting member 402 (a first abutting unit and a second abutting unit) that abuts on the belt unit side plate 313 is provided at the back-side tip end of the adjustment screw 404. Therefore, the force of pulling the adjustment frame 405 to the front side changes according to the expansion and contraction of the spring member 403, whereby the force of pushing the abutting member 402 from the front side toward the back side changes. For example, in a case where the interval between the adjustment frame 405 and the front attachment member 311a has been narrowed, and the spring member 403 has contracted, a pressing force of the abutting member 402 that press the belt unit side plate 313 becomes large. On the other hand, in a case where the interval between the adjustment frame 405 and the front attachment member 311a has been widened, and the spring member 403 has expanded, the pressing force of the abutting member 402 that press the belt unit side plate 313 becomes small. The belt unit side plate 313 deform by being pressed by the abutting member 402.

The pressing mechanism 401 is disposed at each of the left and right positions at which the pressing mechanisms 401 can press each of the left and right belt unit side plates 313 from the front side (a first pressing mechanism and a second pressing mechanism). In the present embodiment, one of the two pressing mechanisms 401 is capable of pressing the left belt unit side plate 313 in a first direction intersecting with the rotation axis direction of the heating roller 307, and the other pressing mechanism 401 is capable of pressing the right belt unit side plate 313 in a second direction intersecting with the rotation axis direction of the heating roller 307. The first direction and the second direction may be the same direction.

As shown in FIG. 2, in the cover member 312, adjustment openings 406 (a first opening portion and a second opening portion) communicating with the outside are formed at left and right positions overlapping with the head portions of the adjustment screws 404 (a first adjustment unit and a second adjustment unit) as viewed from the front side. In the present embodiment, the adjustment opening 406 may further include a lid that is fitted with the adjustment opening 406 in the cover member 312 and suppresses contact with the outside. The lid is formed of the same material as the cover member 312 and can be opened and closed for an adjustment operation. The adjustment opening 406 is formed to be large enough for a tool for rotating the adjustment screw 404 to be inserted in order to access the adjustment screw 404 in the fixing frame 8A. The operator can insert, for example, a driver from the adjustment opening 406 and rotate the adjustment screw 404 with the driver. The operator can adjust the pressing force of the pressing mechanism 401 against the belt unit side plate 313 by changing the rotation direction of the adjustment screw 404. The pressing force of the pressing mechanism 401 installed at each of the left and the right is adjusted, whereby the amount of deformation of each of the left and right belt unit side plates 313 changes.

In the cover member 312, no openings are formed in a portion that connects the adjustment openings 406 (the first opening portion and the second opening portion) formed on the left and the right, respectively. That is, in the cover member 312, a wall portion 3121 that separates the inside and the outside of the cover member 312 is provided between the left and right adjustment openings 406 (refer to FIG. 10). The adjustment openings 406 are provided to enable the operator to operate the pressing mechanism 401 even in a state where the cover member 312 is closed. However, the thermal insulating performance, which is the intrinsic purpose of the cover member 312, deteriorates as much as the openings being provided. Therefore, the opening formed in the cover member 312 should be minimized, and the opening is not formed in the portion that connects the left and right adjustment openings 406. In other words, in the cover member 312, a portion between the left and right adjustment openings 406 (a portion between the first opening portion and the second opening portion) is blocked.

As described above, in the present embodiment, the pressing mechanism 401 that can be operated by the operator from the outside of the fixing frame 8A is provided. In addition, the pressing force of the pressing mechanism 401 with respect to the belt unit side plate 313 is adjusted in accordance with the operator's operation, whereby each of the left and right belt unit side plates 313 can be deformed. Each of the left and right belt unit side plates 313 is deformed as described above, whereby the alignment between the heating roller 307 and the steering roller 308 supported by the belt unit side plates 313 is adjusted. The alignment adjustment by deforming the belt unit side plate 313 needs to be performed to an extent that belt tracking can be suppressed by the steering roller 308 after the adjustment. The operator can operate the pressing mechanism 401 from the outside of the fixing frame 8A, and thus can easily adjust the alignment.

### Second Embodiment

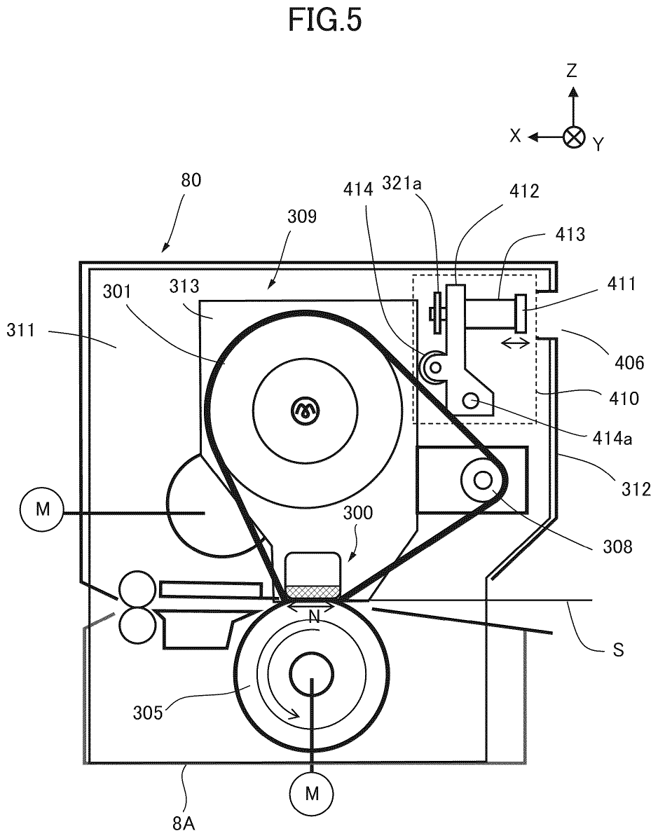

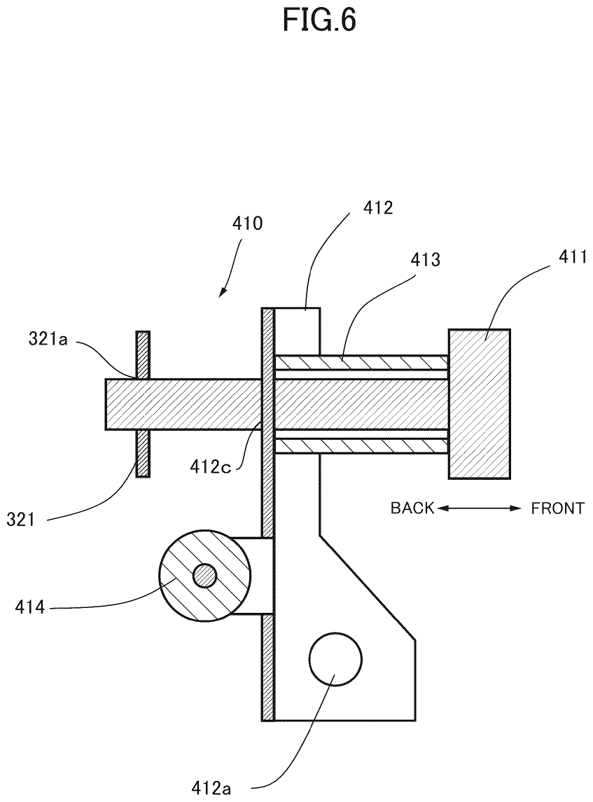

Next, a second embodiment will be described using FIG. 5 and FIG. 6. FIG. 5 shows a fixing device of the second embodiment, and FIG. 6 shows a pressing mechanism of the second embodiment. A fixing device 80 of the second embodiment shown in FIG. 5 is different from the fixing device 8 of the first embodiment shown in FIG. 2 only in the configuration of a pressing mechanism 410, and the other configurations are the same. Therefore, the same configuration as that of the fixing device 8 according to the first embodiment described above will be denoted by the same reference numeral, and the description thereof will be simplified or omitted.

As shown in FIG. 5 and FIG. 6, the pressing mechanism 410 is composed of an adjustment screw 411, a swing lever 412, a spring member 413, and an attachment member 321. In the second embodiment, as in the first embodiment, the pressing mechanism 410 is disposed at each of the left and right positions at which the pressing mechanisms 410 can press each of the left and right belt unit side plates 313 from the front side. The pressing mechanism 410 is attached to the fixing frame 8A via the attachment member 321 fixed to the fixing frame 8A (specifically, the frame side plates 311) in advance and the swing lever 412. The swing lever 412 is supported to be capable of swinging around a swing shaft 412a provided to protrude from the frame side plate 311.

A helical groove is formed in the shaft portion of the adjustment screw 411, and a screw hole 321a that meshes with the shaft portion of the adjustment screw 411 is formed in the attachment member 321. That is, the adjustment screw 411 is reciprocally movable in the front-back direction with respect to the attachment member 321 by rotation. A through hole 412c is formed in the swing lever 412, and the shaft portion of the adjustment screw 411 is inserted into this through hole 412c. In addition, in a state where the shaft portion of the adjustment screw 411 has been inserted into the through hole 412c in the swing lever 412, the spring member 413 inserted into the shaft portion of the adjustment screw 411 is disposed between the swing lever 412 and the head portion of the adjustment screw 411. The spring member 413 is connected to the swing lever 412 at one end and connected to the head portion of the adjustment screw 411 at the other end and is provided to swing the swing lever 412 back and forth.

The swing lever 412 is provided with a protruding portion 414 that protrudes backward between the through hole 412c and the swing shaft 412a. This protruding portion 414 abuts on the belt unit side plate 313. In a case where the adjustment screw 421 has been rotated and moved backward, since the protruding portion 414 is in a state of abutting on the belt unit side plate 313, the interval between the swing lever 412 and the head portion of the adjustment screw 411 is narrowed, and the spring member 413 contracts. In a case where the spring member 413 contracts, a force of pushing the swing lever 412 backward becomes large, and the pressing force of the protruding portion 414 that presses the belt unit side plate 313 thus becomes larger. On the other hand, in a case where the adjustment screw 414 is rotated and moved forward, the interval between the swing lever 412 and the head portion of the adjustment screw 411 is widened, and the spring member 413 expands. In a case where the spring member 413 expands, the force of pushing the swing lever 412 backward becomes small, and a pressing force of the protruding portion 414 that presses the belt unit side plate 313 thus becomes larger. In this way, the belt unit side plate 313 deform by being pressed by the protruding portion 414 of the swing lever 412.

As shown in FIG. 5, in the cover member 312, the adjustment opening 406 is formed at a position overlapping with the head portion of the adjustment screw 411 as viewed from the front side. Therefore, the operator can insert, for example, a driver from the adjustment opening 406 and rotate the adjustment screw 411 with the driver. The operator can change the pressing force of the pressing mechanism 410 against the belt unit side plate 313 by changing the rotation direction of the adjustment screw 411. The pressing forces of the pressing mechanisms 410 installed at the left and the right, respectively, are changed, whereby the amounts of deformation of the left and right belt unit side plates 313 changes, respectively. Accordingly, the alignment between the heating roller 307 and the steering roller 308 supported by the belt unit side plates 313 is adjusted. The operator can operate the pressing mechanism 410 from the outside of the fixing frame 8A, and thus can easily adjust the alignment.

### Third Embodiment

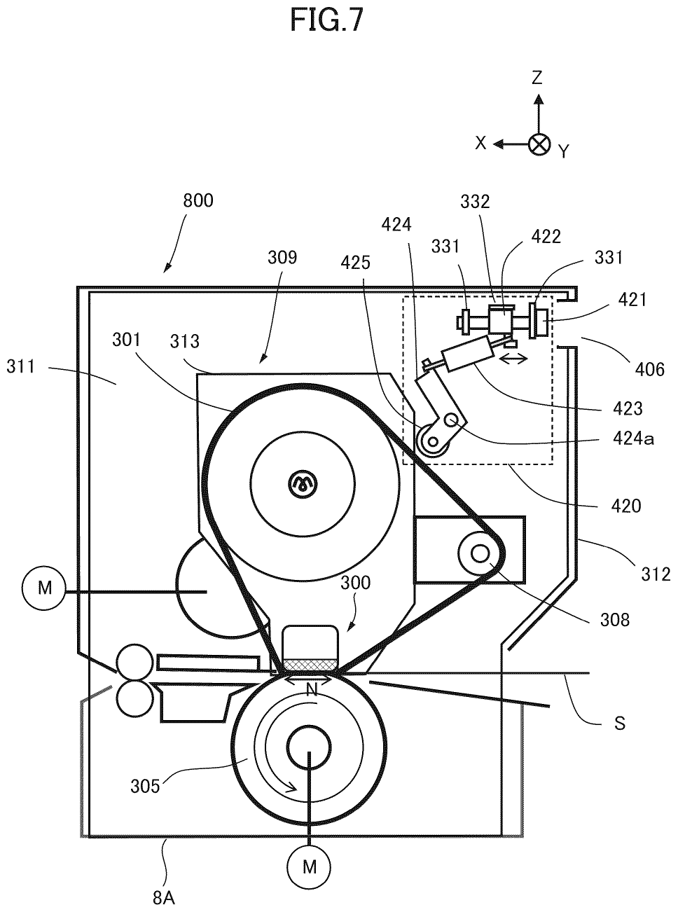

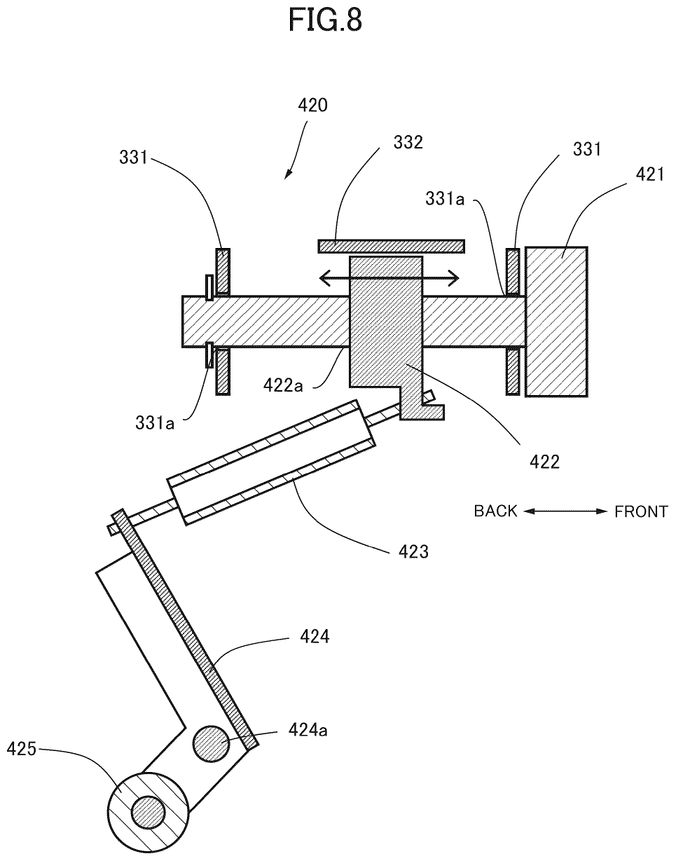

Next, a third embodiment will be described using FIG. 7 and FIG. 8. FIG. 7 shows a fixing device of the third embodiment, and FIG. 8 shows a pressing mechanism of the third embodiment. A fixing device 800 of the third embodiment shown in FIG. 7 is different from the fixing device 8 of the first embodiment shown in FIG. 2 only in the configuration of a pressing mechanism 420, and the other configurations are the same. Therefore, the same configuration as that of the fixing device 8 according to the first embodiment described above will be denoted by the same reference numeral, and the description thereof will be simplified or omitted.

As shown in FIG. 7 and FIG. 8, the pressing mechanism 420 is composed of the adjustment screw 421, an adjustment frame 422, a spring member 423, a swing lever 424, an attachment member 331, and a rotation restricting member 332. In the third embodiment, as in the first embodiment, the pressing mechanism 420 is disposed at each of the left and right positions at which the pressing mechanisms 420 can press each of the left and right belt unit side plates 313 from the front side. The pressing mechanism 420 is attached to the fixing frame 8A via two attachment members 331 fixed to the fixing frame 8A (specifically, the frame side plates 311) in advance. The attachment members 331 are disposed side by side at an interval in the front-back direction. Through holes 331a are formed in the attachment members 331, and the shaft portion of the adjustment screw 421 is inserted into these through holes 331a, whereby the adjustment screw 421 is supported by the attachment members 331 so as to be reciprocally movable in the front-back direction.

In the adjustment screw 421 supported by the two front and back attachment members 331, the adjustment frame 422 is disposed between the attachment members 331. The adjustment frame 422 is formed in, for example, a polygonal shape such as a hexagonal shape. A helical groove is formed in the shaft portion of the adjustment screw 421, and a screw hole 422a that meshes with the shaft portion of the adjustment screw 421 is formed in the adjustment frame 422. That is, the adjustment frame 422 is provided to allow the shaft portion of the adjustment screw 421 to move by the rotation of the adjustment screw 421.

In the present embodiment, the rotation restricting member 332 is fixed to the fixing frame 8A in the same manner as the attachment members 331. The rotation restricting member 332 abuts on one surface of the outer peripheral surface of the adjustment frame 422, and restricts the rotation of the adjustment frame 422 such that the adjustment frame 422 does not rotate together with the adjustment screw 421 in a case where the adjustment screw 421 is rotated. Accordingly, along with the rotation of the adjustment screw 421, the adjustment frame 422 can reciprocally move the shaft portion of the adjustment screw 421, and the position of the adjustment frame 422 on the shaft portion of the adjustment screw 421 changes. For example, in a case where the adjustment screw 421 is rotated clockwise, the adjustment frame 422 moves from the back side to the front side with respect to the shaft portion, and in a case where the adjustment screw 421 is rotated counterclockwise, the adjustment frame 422 moves from the front side to the back side with respect to the shaft portion.

One end of the spring member 423 is connected to, among the outer peripheral surfaces of the adjustment frame 422, a surface opposite to the surface regulated by the rotation restricting member 332. In the present embodiment, the swing lever 424 is supported to be capable of swinging around a swing shaft 424a provided to protrude from the frame side plate 311. The other end of the spring member 423 is connected to one end side of the swing lever 424. That is, the spring member 423 is stretched by the adjustment frame 422 and the swing lever 424. In addition, the swing lever 424 is provided with an abutting member 425 on the other end side opposite to one end side to which the spring member 423 is connected. The abutting member 425 abuts on the belt unit side plate 313.

In a case where the adjustment frame 422 has moved forward with respect to the shaft portion of the adjustment screw 421 by the rotation of the adjustment screw 421, since the abutting member 425 is in a state of abutting on the belt unit side plate 313, the spring member 423 expands. In a case where the spring member 423 expands, since the force of pulling one end side of the swing lever 424 to the front side becomes large, the pressing force of the abutting member 425 on the other end side that presses the belt unit side plates 313 becomes large. On the other hand, in a case where the adjustment frame 422 has moved backward by the rotation of the adjustment screw 421, the spring member 423 contracts. In a case where the spring member 423 contracts, since the force of pulling one end side of the swing lever 424 to the front side becomes small, the pressing force of the abutting member 425 on the other end side that presses the belt unit side plate 313 becomes small. In this way, the belt unit side plate 313 deform by being pressed by the abutting member 425 of the swing lever 424.

As shown in FIG. 7, in the cover member 312, the adjustment opening 406 is formed at a position overlapping with the head portion of the adjustment screw 421 as viewed from the front side. Therefore, the operator can insert, for example, a driver from the adjustment opening 406 and rotate the adjustment screw 421 with the driver. The operator can change the pressing force of the pressing mechanism 420 against the belt unit side plate 313 by changing the rotation direction of the adjustment screw 421. The pressing forces of the pressing mechanisms 420 installed at the left and the right, respectively, are changed, whereby the amounts of deformation of the left and right belt unit side plates 313 changes, respectively. Accordingly, the alignment between the heating roller 307 and the steering roller 308 supported by the belt unit side plates 313 is adjusted. The operator can operate the pressing mechanism 420 from the outside of the fixing frame 8A, and thus can easily adjust the alignment.

### Other Embodiments

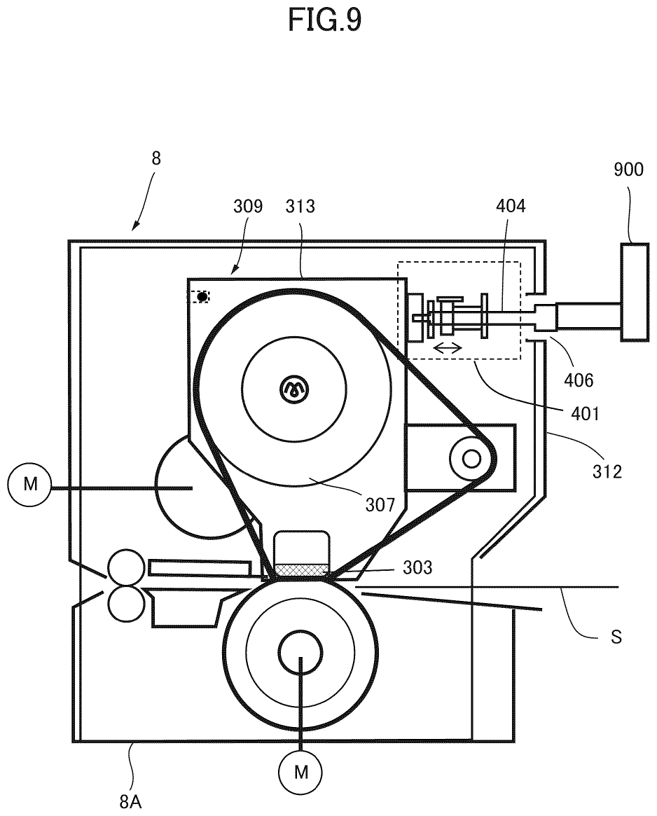

In each of the above-described embodiments, the operator inserts a tool such as a driver from the adjustment opening 406 and rotates the adjustment screw (404, 411, or 421), but the present invention is not limited thereto. For example, the operator may be enabled to grip the adjustment screw (404, 411, or 421) by hands and rotate the adjustment screw (404, 411, or 421). In order for that, at least a part of the adjustment screw (404, 411, or 421) may be exposed to the outside of the cover member 312 through the adjustment opening 406. In addition, as shown in FIG. 9, for example, it is preferable that a grip portion 900 is provided at a portion of the adjustment screw 404 that is exposed to the outside of the cover member 312, and the operator can operate the adjustment screw (404, 411, or 421) to rotate by gripping the grip portion 900.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2024-035941, filed Mar. 8, 2024, which is hereby incorporated by reference herein in its entirety.

What is claimed is:

1. A fixing device that fixes a toner image formed on a recording material to the recording material, comprising:
a belt unit including:
a rotating endless belt;
a stretching roller disposed inside the belt and configured to stretch the belt;
a first support plate supporting one end portion of the stretching roller in a rotation axis direction; and
a second support plate supporting the other end portion of the stretching roller in the rotation axis direction;
a rotatable pressing member disposed outside the belt and forming a nip portion capable of sandwiching and conveying the recording material together with the belt;
a frame supporting the first support plate and the second support plate;
an adjustment unit provided on the frame and being capable of adjusting a position of the first support plate in a direction intersecting with the rotation axis direction; and
a cover member covering the belt unit, the frame, and the adjustment unit,
wherein the cover member includes an opening portion formed at a position corresponding to the adjustment unit and communicating with an outside.

2. The fixing device according to claim 1, wherein
the adjustment unit is configured to adjust the position of the first support plate by pressing the first support plate in the direction intersecting with the rotation axis direction.

3. The fixing device according to claim 2, wherein
the adjustment unit further includes
an operation unit receiving an operation of adjusting a pressing force of the adjustment unit,
an abutting unit abutting on the first support plate, and
an elastic member for urging the abutting unit toward the first support plate, and the operation unit is capable of adjusting an urging force of the elastic member.

4. The fixing device according to claim 3, wherein
the operation unit can be operated from an outside of the cover member by a tool inserted through the opening portion.

5. The fixing device according to claim 3, wherein
the operation unit is at least partially exposed to an outside of the cover member through the opening portion and can be operated on the outside of the cover member.

6. The fixing device according to claim 1, wherein
the belt unit further includes a steering roller configured to stretch the belt together with the stretching roller inside the belt and control a position of the belt in the rotation axis direction by tilting with respect to the rotation axis direction.

7. The fixing device according to claim 6, wherein
the steering roller is supported by the first support plate and the second support plate such that the steering roller can be tilted with respect to the rotation axis direction.

8. The fixing device according to claim 1, further comprising:
a stretching member disposed inside the belt and configured to stretch the belt together with the stretching roller,
wherein the stretching member includes
a pad member abutting on an inner peripheral surface of the belt, and
a stay supporting the pad member,
both end portions of the stay in the rotation axis direction are fixed to the first support plate and the second support plate, and
portions of the stay that protrude outward from the first support plate and the second support plate in the rotation axis direction are support portions supporting the first support plate and the second support plate on the frame.

9. The fixing device according to claim 1, wherein
the cover member includes an openable lid configured to fit into the opening portion.

10. The fixing device according to claim 1, further comprising:
a second adjustment unit provided on the frame and being capable of adjusting a position of the second support plate in the direction intersecting with the rotation axis direction,
wherein the cover member further includes a second opening portion formed at a position corresponding to the second adjustment unit and communicating with the outside.

11. The fixing device according to claim 10, wherein
the cover member includes a wall portion separating an inside and an outside of the cover member between the opening portion and the second opening portion.
